(19) United States
(12) Patent Application Publication
(10) Pub. No.: US 2012/0278636 A1
(43) Pub. Date: Nov. 1, 2012

(54) REMOTE WAKE MECHANISM FOR A NETWORK SYSTEM AND REMOTE WAKE METHOD THEREOF

(75) Inventors: Chien-Hao Lin, Chang Hua County (TW); Sheng-Kai Hung, Hsin Chu County (TW); Meng-Han Hsieh, Hsin Chu City (TW); Kai-Wen Cheng, Hsin Chu County (TW)

(73) Assignee: Realtek Semiconductor Corp., Hsinchu (TW)

(21) Appl. No.: 13/454,847

(22) Filed: Apr. 24, 2012

(30) Foreign Application Priority Data
Apr. 26, 2011 (TW) 100114381

(51) Int. Cl. G06F 15/16; G06F 21/00; G06F 1/00

(52) U.S. Cl. 713/300; 709/218

(57) ABSTRACT

A network system with wake-up on LAN (WOL) mechanism and a wake-up on LAN method are disclosed. The network system includes: a first network device in a first local area network; a second network device in a second local area network, wherein the first local area network and the second local area network are different; and, a match server in a wide area network, wherein the first network device and the second network device perform data transmission through the match server.

### BACKGROUND OF THE INVENTION

1. Field of the Invention

The invention relates to a network device, particularly to an energy saving network device.

2. Description of the Related Art

Due to the fast growth of computers and mobile phones, many users share data or software of their computers via internet, or control remote computers via remote control software, such as a network neighborhood in a local area network (LAN) or a file transfer protocol (FTP) in a wide area network (WAN). However, users may need a network address translation (NAT) in different LANs to share their computer data or software via internet. These services are provided on demand. When the services are not needed, computers are expected to enter a power saving mode of S3 (sleep state) or S4 (hibernation state) for saving power consumption.

However, more and more people connect to WAN through NAT as the number of IPv4 address is limited and gradually gets used up. NAT technology allows one public network address to be shared by multiple private network addresses. Therefore, it is not necessary for each of a mass of users to have an individual fixed network address to surf the internet in view of the limited number of IPv4 addresses.

Currently, Ethernet provides a wake-up on LAN (WOL) function. WOL technology can quickly resume a computer from S3 or S4 state to S0 state (fully on state). The technology can bring a computer into a power saving mode of S3 or S4 when the computer is not in use, and quickly get the computer back to work when a remote user needs to use computer resources, therefore achieving the goal of saving energy.

However, using the WOL technology comes with several problems. For example, it works only in a LAN, but it cannot in a WAN. For another example, it is necessary to store the media access control address (MAC address) of the computer which needs to be woken up. For another example, it lacks security authentication. For example, the computer of the other party can be woken up by its known MAC address or further adding a plaintext password. For another example, it operates with broadcast packets, and thus all the computers in the same LAN need to deal with the broadcast packets.

### SUMMARY OF THE INVENTION

In view of the above-mentioned problems, an object of the invention is to provide a network device, allowing users to wake up remote network devices in different LANs over WAN.

An embodiment of the invention provides a wake-up on WAN technology, which has a security authentication function to identify users, and allows users to control remote devices through a correspondence between user ID and IP address.

An embodiment of the invention provides a network device, which can wake up the other devices (e.g., household appliances) and the computers in the same LAN, and which can also allow remote users to control the household appliances or wake up the other computers in the same LAN without starting up the computer.

An embodiment of the invention improves the conventional WOL technology such that computers in different LANs can quickly resume remote devices from S3 or S4 state to S0 state (fully on state) through WAN. The embodiment also includes an invented security authentication which allows a remote device to determine whether to execute the wake-up process. Instead of storing an unreadable string, the invented security authentication only requires a user to register a readable string to be corresponded to the address of the remote device. To relieve the loading of the other devices, a wake-up command is transferred in a unicast manner other than a broadcast manner. In order to save energy of the conventional WOL devices in different LANs, a magic packet proxy solution is provided to allow the conventional WOL devices to be woken up by the computers in a WAN or different LANs. Further, the WOL technology can also be applied to the wake-up and control of household appliances since the general purpose I/O (GPIO) pins of the Green Cloud Ethernet card are currently converted from waking up the computers conventionally into controlling the other household appliances. For example, the power switches of the household appliances can be controlled, or various household appliances are controlled by infrared transmitters. In such a control matter, it is not necessary to start up the computer or to install control software on the computer, thereby providing a solution together with an excellent price-performance ratio in addition to saving energy.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic diagram showing a user environment configuration according to an embodiment of the invention.

FIG. 2 is an operation flow of a wake-up on LAN according to an embodiment of the invention.

FIG. 3 is an operation flow of a magic packet proxy technology according to an embodiment of the invention.

### DETAILED DESCRIPTION OF THE INVENTION

In this specification and the appended claims, some specific words are used to describe specific elements. It should be understood by those who are skilled in the art that some hardware manufacturer may use different names to indicate the same element. In this specification and the appended claims, elements are not differentiated by their names but their functions.

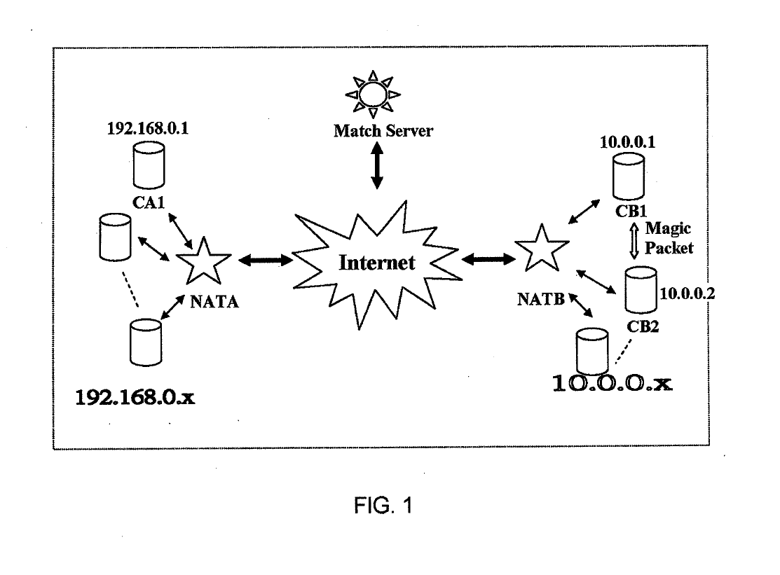

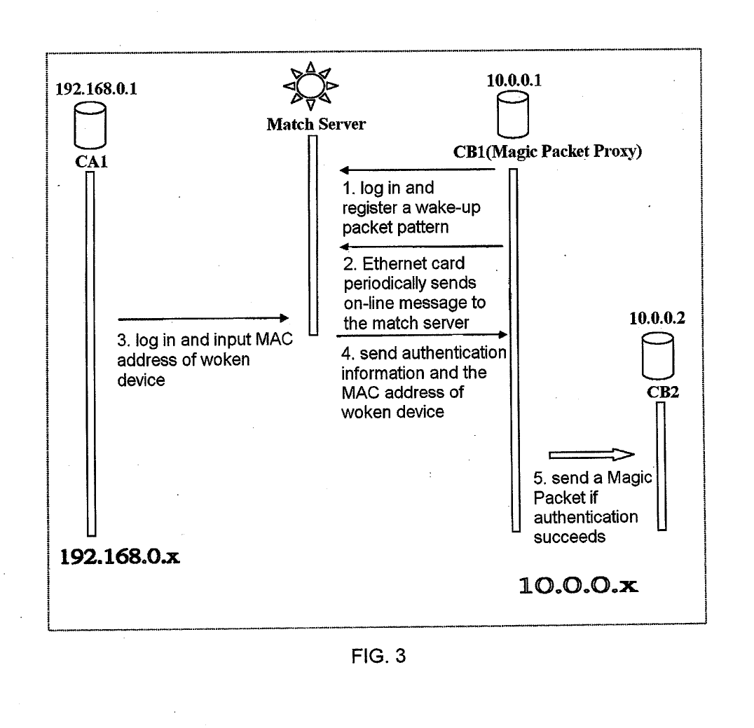

In an embodiment, a user environment configuration is set as shown in FIG. 1. A user has two network devices (a second network device CA1 and a first network device CB1). The second network device CA1 and the first network device CB1 are respectively in two different LANs, for example 192.168.0.x and 10.0.0.x. The second network device CA1 is a general device capable of connecting to internet and the first network device CB1 is a device with an embedded green cloud Ethernet card. As shown in FIG. 3, a third network device CB2 is compliant with the conventional WOL technology. According to the conventional or well-known WOL technology, the second network device CA1 can not directly wake up the first network device CB1 through a WAN. In an embodiment of the invention, a match server is configured to locate at an intermediate position between the second network device CA1 and the first network device CB1. In addition, the match server is in a WAN and functions as a communication bridge between the second network device CA1 and the first network device CB1.

When the second network device CA1 or the third network device CB2 attempts to use the WOL mechanism, its user is required to log in to the match server for identity authentication to improve the problem of lacking security authentication existed in the conventional WOL mechanism. Meanwhile, to improve the problem of storing the MAC address of the computer in the conventional WOL mechanism, the correspondence between the user account number and IP address is activated by logging in to the account. Besides, since the match server already gets the IP address, the match server can perform unicast instead of broadcast used by the conventional WOL mechanism. Thus, the loading of the other network devices in the same LAN can be relieved.

Furthermore, in order to allow the conventional WOL devices to be woken up by different network device crossed different network, a embodiment of the invention allows the second network device CA1 to send the MAC address of the third network device CB2 to the first network device CB1. After that, the first network device CB1 sends a magic packet to the third network device CB2. Based on such a configuration, the first network device CB1 works as a WOL proxy without being started up. Accordingly, the first network device CB1 can save energy and the computers without a Green Cloud Ethernet card in the same LAN (such as CB2) can be woken up via the WOL technology.

Further through the communication between the match server and the Green Cloud Ethernet card, different packets are used to control voltage levels of GPIO, to thereby control household appliances.

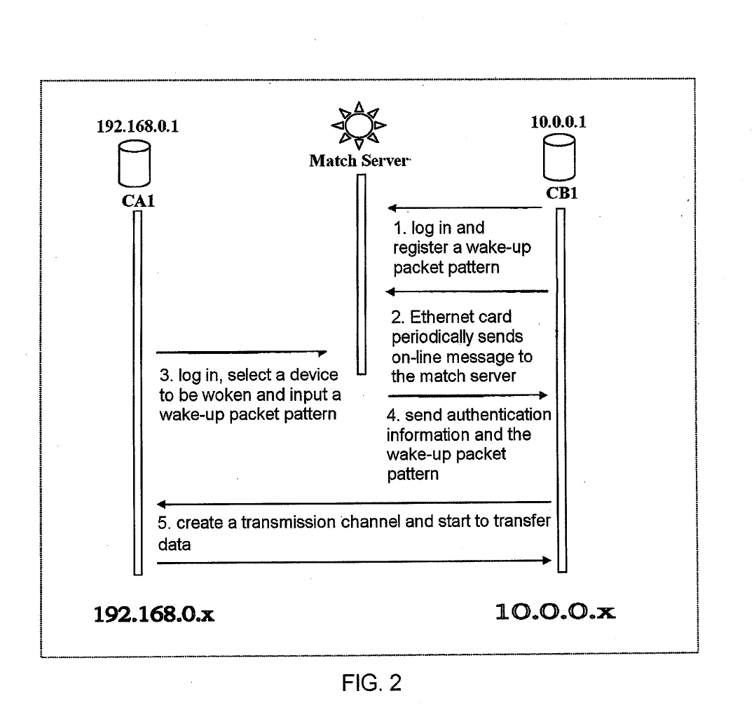

FIG. 2 shows an embodiment of a method of wake-up on LAN (WOL) applicable to a network system. The method includes following steps:

Step 1: Firstly, the first network device CB1 with a Green Cloud Ethernet card of an embodiment of the invention logs in to the remote match server and sets a specific wake-up packet pattern. The first network device CB1 may store the wake-up packet pattern. For example, the match server transfers related wake-up information to the Green Cloud Ethernet card. The first network device CB1 enters S3 or S4 mode after the energy saving mode is set by user or a timer.

Step 2: The Green Cloud Ethernet card periodically sends on-line messages to the remote match server to enable a network address translation (NAT) device to keep the communication channel between the first network device CB1 and the match server.

Step 3: When a user operates the second network device CA1 to access data in the first network device CB1, the user needs to log in to the match server and then input the wake-up packet pattern.

Step 4: The match server transfers the wake-up packet pattern to the first network device CB1. Then, the first network device CB1 authenticates after receiving the wake-up packet pattern.

Step 5: If authentication succeeds, the first network device CB1 enters S0 mode from S3 or S4 mode. Next, the second network device CA1 and the first network device CB1 use a predetermined protocol to create a transmission channel for data transmission.

FIG. 3 shows a flow chart of the magic packet proxy technology according to an embodiment of the invention. It allows a conventional WOL device to be woken up by the computers in a WAN or different LANs. The flow of the magic packet proxy technology is described as follows.

Step 1 and Step 2 of FIG. 3 are similar to the Step 1 and Step 2 of FIG. 2.

Step 3: After logging in to the match server, the second network device CA1 inputs MAC address of the third network device CB2 to the match server.

Step 4: The match server sends the MAC address of the third network device CB2 to the first network device CB1.

Step 5: Authentication information is transferred to the first network device CB1 and then the first network device CB1 sends a magic packet to the third network device CB2 according to the MAC address of the third network device CB2.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A network system, comprising:
a first network device in a first local area network (LAN);
a second network device in a second local area network, wherein the first local area network are different local area networks; and
a match server in a wide area network, wherein the first network device and the second network device perform data transmission through the match server.

2. The system according to claim 1, wherein the first network device logs in to the match server to set a wake-up packet pattern, and wherein when the second network device attempts to access data in the first network device, a user is required to log in to the match server to input the wake-up packet pattern to thereby enable the first network device to authenticate and determine whether to be woken up and transmit data.

3. The system according to claim 1, further comprising:
a third network device, wherein the third network device and the first network device are in the same local area network.

4. The system according to claim 3, wherein the first network device includes an embedded Green Cloud Ethernet card, the second network device is a device capable of connecting to internet, and the third network device is compliant with wake-up on LAN (WOL) technology.

5. The system according to claim 3, wherein after the second network device logs in to the match server and sends a media access control (MAC) address of the third network device to the first network device, the first network device sends a magic packet to the third network device to wake up the third network device in accordance with the MAC address.

6. The system according to claim 5, wherein a device equipped with the first network device is in a shut-down state or a standby state.

7. The system according to claim 3, wherein when the second network device or the third network device attempts to communicate with the first network device by using the wake-up on LAN (WOL) mechanism, the first network device requires users to log in to the match server to perform identity authentication for security authentication.

8. The system according to claim 1, wherein the first network device controls operations of household appliances by controlling a voltage level of general purpose input output pins.

9. A wake-up on LAN (WOL) method applicable to a network system, the network system comprising a first network device, a second network device and a match server, wherein the first network device and the second network device are in different local area networks and the match server is in a wide area network, the method comprising:
the first network device logging in to the match server and setting a wake-up packet;
when the second network device attempts to access data in the first network device, the second network device logging in to the match server and sending a wake-up packet pattern to the match server; and
the match server transferring the wake-up packet pattern to the first network device to determine whether to be woken up for data transmission.

10. The method according to claim 9, wherein the first network device sends an on-line message to the match server to keep in connection with the match server.

11. The method according to claim 9, wherein the first network device receives the wake-up packet pattern and authenticates if the wake-up packet pattern equals to the specific wake-up packet pattern, and wherein the first network device and the second network device create a transmission channel by using a predetermined communication protocol if the authentication succeeds.

12. A wake-up on LAN (WOL) method applicable to a network system, the network system comprising a first network device, a second network device, a third network device and a match server, wherein the first network device and the second network device are in different local area networks, wherein the first network device and the third network device are in a same local area network and the match server is in a wide area network, the method comprising:
the first network device logging in to the match server and setting a specific wake-up packet pattern;
when the second network device attempts to wake up the third network device, the second network device logging in to the match server, and sending a wake-up packet pattern and a media access control (MAC) address of the third network device to the match server;
the match server transferring the wake-up packet pattern and the MAC address to the first network device; and
the first network device authenticating if the wake-up packet pattern equals to the specific wake-up packet pattern to determine whether to wake up the third network device for performing data transmission with the second network device.

13. The method according to claim 12, wherein the first network device continuously sends an on-line message to the match server to keep in connection with the match server.

14. The method according to claim 12, wherein the step of authenticating further comprises:
the first network device sending a magic packet to the third network device to wake up the third network device if the authentication succeeds.

15. A method of wake-up on LAN (WOL) applicable to a network system, the network system comprising a first network device, a second network device, and a match server, wherein the first network device and the second network device are in different local area networks, and the match server is in a wide area network, the method comprising:
the first network device logging in to the match server and setting an authentication related information; and
when the second network device wakes up the first network device, the second network device asking the match server to make the first network device authenticate the authentication related information and determine whether to wake up the first network device for data transmission.

16. The method according to claim 15, wherein the network system comprises a third network device, wherein the first network device and the third network device are in a same local area network, the method further comprising:
when the second network device wakes up the third network device, the second network device sending the authentication related information and a media access control (MAC) address of the third network device to the first network device through the match server to authenticate the authentication related information and to determine whether to wake up the third network device for data transmission.
